(19) United States
(12) Patent Application Publication
(10) Pub. No.: US 2018/0165681 A1
(43) Pub. Date: Jun. 14, 2018

(54) Unauthorized Usage Detection Using Transaction Management and Analytics Platforms

(71) Applicant: Bank of America Corporation, Charlotte, NC (US)

(72) Inventors: Aron Megyeri, Kennett Square, PA (US); Craig Douglas Widmann, Chandler, AZ (US); Eduardo J. Ramirez, Wilmington, DE (US); Amijo Bearley, Oxford, PA (US); Robert D. Jones, Wilmington, DE (US)

(73) Assignee: Bank of America Corporation, Charlotte, NC (US)

(21) Appl. No.: 15/376,252

(22) Filed: Dec. 12, 2016

(51) Int. Cl. G06Q 20/40; G06Q 20/10

(52) U.S. Cl. CPC G06Q 20/4016; G06Q 20/1085

(57) ABSTRACT

Aspects of the disclosure relate to detection of unauthorized usage in debit card transactions using a transaction management computing platform and an analytics computing platform. A computing platform may monitor a plurality of transactions at an automated teller machine. Subsequently, the computing platform may identify at least one unusual activity in the plurality of transactions at the automated teller machine. In response to identifying the at least one unusual activity in the plurality of transactions, the computing may analyze each account corresponding to the plurality of transactions to identify a common point of purchase for a subset of accounts. Thereafter, the computing platform may flag the subset of accounts for unauthorized usage.

### FIELD

Aspects of the disclosure relate to electrical computers, data processing systems, and preventing unauthorized access to secure information systems. In particular, one or more aspects of the disclosure relate to detecting unauthorized use of secure information systems using a transaction management computing platform and an analytics computing platform.

### BACKGROUND

As computer systems are increasingly utilized to provide automated and electronic services for managing transactions, such computer systems may obtain and maintain increasing amounts of various types of sensitive information, and ensuring the safety and security of this information may be increasingly important. In some instances, confidential or sensitive information may be compromised, resulting in unauthorized usage of information at automated teller machines (ATMs). It may be difficult for computer systems to identify when information has been compromised and prevent additional unauthorized usage from occurring at ATMs.

### SUMMARY

Aspects of the disclosure provide effective, efficient, scalable, and convenient technical solutions that address and overcome the technical problems associated with preventing unauthorized use and optimizing the efficient and effective technical operations of computer systems. In particular, one or more aspects of the disclosure provide techniques for detecting unauthorized usage of debit cards at automated teller machines (ATMs) using a transaction management computing platform and an analytics computing platform to prevent unauthorized usage and enhance technical performance.

In accordance with one or more embodiments, a computing platform having at least one processor, a memory, and a communication interface may monitor a plurality of transactions at an automated teller machine. Subsequently, the computing platform may identify at least one unusual activity in the plurality of transactions at the automated teller machine. In response to identifying the at least one unusual activity in the plurality of transactions, the computing may analyze each account corresponding to the plurality of transactions to identify a common point of purchase for a subset of accounts. Thereafter, the computing platform may flag the subset of accounts for unauthorized usage. In some embodiments, the computing platform may subsequently transmit a notification to each user device associated with users of the subset of accounts.

In some embodiments, to identify the at least one unusual activity, the computing platform may identify a frequency value of the plurality of transactions that occurred over a predetermined period of time at the automated teller machine. The computing platform may then determine that the frequency value of the plurality of transactions that occurred over the predetermined period of time exceeds a predetermined threshold level. In some instances, the predetermined threshold level corresponds to a baseline value for previous transactions occurring over the predetermined period of time based on transaction history at the automated teller machine. In some instances, the computing platform may determine the predetermined threshold level by calculating an average number of transactions that occur at the automated teller machine over previous predetermined periods of time. Thereafter, the computing platform may adjust the predetermined threshold level according to the average number of transactions.

In some embodiments, to identify the at least one unusual activity, the computing platform may identify a respective period of time between each transaction in the plurality of transactions at the automated teller machine, resulting in a plurality of periods of time. Next, the computing platform may determine that at least one period of time is below a predetermined baseline period of time.

In some embodiments, to identify the at least one unusual activity, the computing platform may identify a length of time for each transaction in the plurality of transactions at the automated teller machine. Subsequently, the computing platform may determine that the length of time for a subset of transactions is below a predetermined baseline length of time.

In some embodiments, to identify the at least one unusual activity, the computing platform may identify an amount for each transaction in the plurality of transactions at the automated teller machine. The computing platform may then determine one or more similarities between transaction amounts for the plurality of transactions at the automated teller machine.

In some embodiments, to identify the at least one unusual activity, the computing platform may identify an amount for each transaction in the plurality of transactions at the automated teller machine. Next, the computing platform may determine that a subset of transaction amounts include amounts above a predetermined threshold value.

In some embodiments, to identify the at least one unusual activity, the computing platform may detect one or more activities occurring during each transaction of the plurality of transactions at the automated teller machine. The computing platform may then identify one or more similarities between the one or more activities of each transaction of the plurality of transactions at the automated teller machine. In some instances, the one or more activities include at least one of inserting debit cards into the automated teller machine, entering personal identification (PIN) numbers, balance inquiries, deposits, and withdrawals at the automated teller machine.

In some instances, monitoring the plurality of transactions at the automated teller machine may include monitoring at least one of an authorization time, length of transaction time, one or more activities occurring during transaction, and a transaction amount for each transaction at the automated teller machine. In some instances, monitoring the plurality of transactions at the automated teller machine may include monitoring video footage received from a camera installed at the automated teller machine. In some embodiments, the plurality of transactions may include withdrawals conducted by one or more users at the automated teller machine.

In some embodiments, to analyze each account corresponding to the plurality of transactions to identify a common point of purchase for a subset of accounts, the computing platform may parse account information for each account corresponding to the plurality of transactions. Next, the computing platform may identify times and locations of previous transactions for each account corresponding to the plurality of transactions. The computing platform may then identify the common point of purchase including a common location at which each account included a previous transaction.

In some embodiments, the common point of purchase may include data regarding a time and location at which account information for at least one account in the subset of accounts was compromised. In some instances, in response to identifying the common point of purchase, the computing platform may detect a second subset of accounts with transactions that occurred at the location at which account information for at least one account in the subset of accounts was compromised. Thereafter, the computing platform may flag the second subset of accounts. In some instances, the computing platform may transmit a notification to each user device associated with users of the second subset of flagged accounts.

These features, along with many others, are discussed in greater detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIGS. 1A-1D depict an illustrative computing environment for detecting unauthorized usage in debit card transactions using a transaction management computing platform, an analytics computing platform, and a statistics computing platform in accordance with one or more example embodiments;

FIGS. 2A-2E depict an illustrative event sequence for detecting unauthorized usage in debit card transactions using a transaction management computing platform, an analytics computing platform, and a statistics computing platform in accordance with one or more example embodiments; and

FIG. 3 depicts an illustrative method for detecting unauthorized usage in debit card transactions using a transaction management computing platform, an analytics computing platform, and a statistics computing platform in accordance with one or more example embodiments.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to detecting unauthorized usage of debit cards at automated transaction machines (ATMs) and flagging accounts to prevent and mitigate the effects of unauthorized usage. For example, an analytics computing platform may interface with a statistics computing platform to identify unusual activity in transaction data obtained from a transaction management computing platform. The analytics computing platform may then implement a common point of purchase (CPP) analysis to identify a common location at which account information corresponding to the transaction data was compromised. In response to identifying the common point or purchase, the analytics computing platform may flag a plurality of accounts with transactions that occurred at the common location at which account information was compromised.

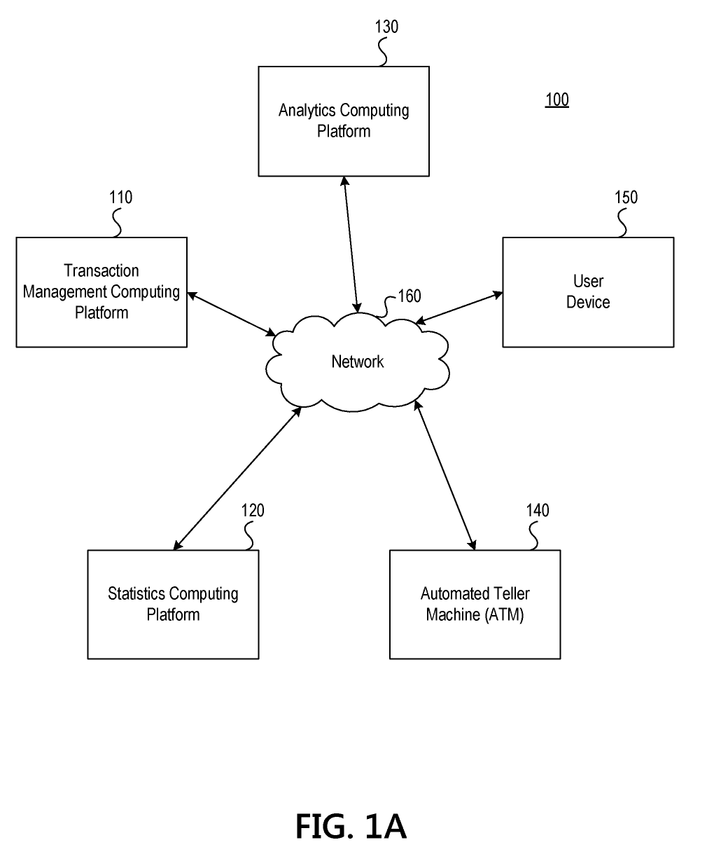

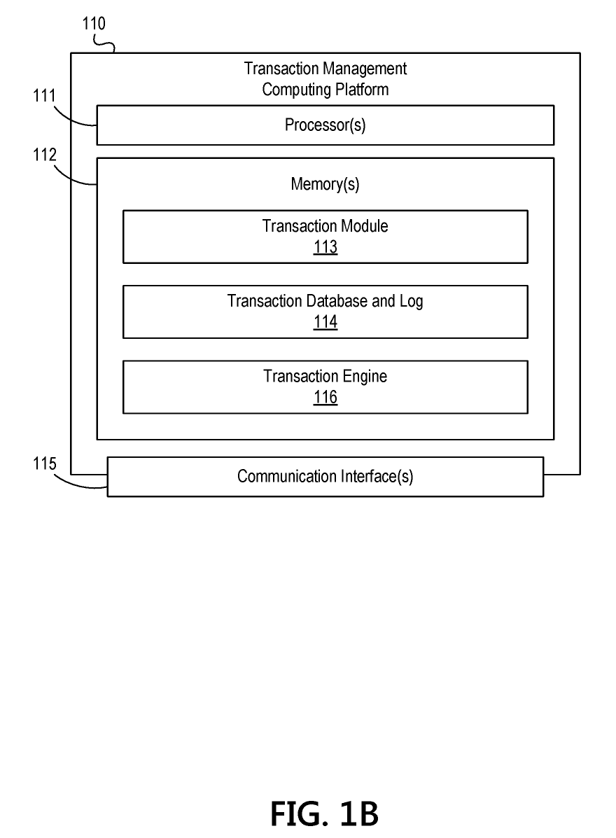

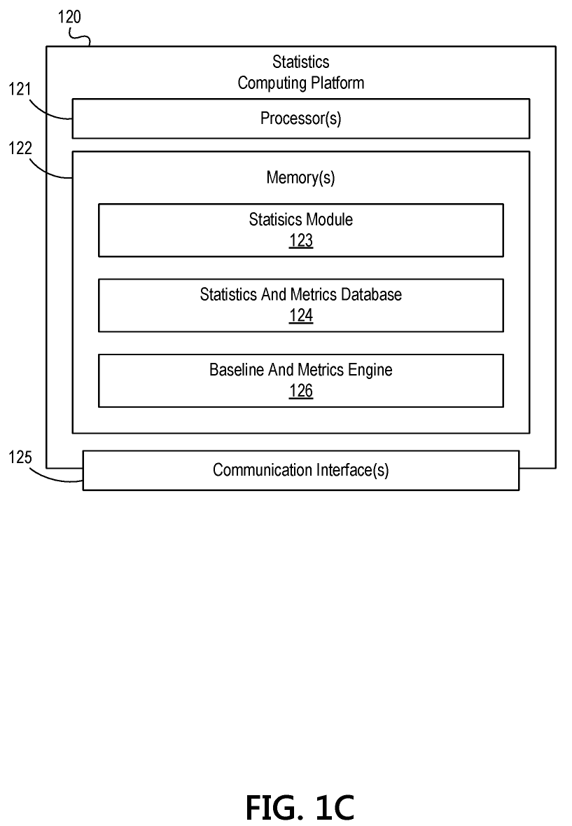

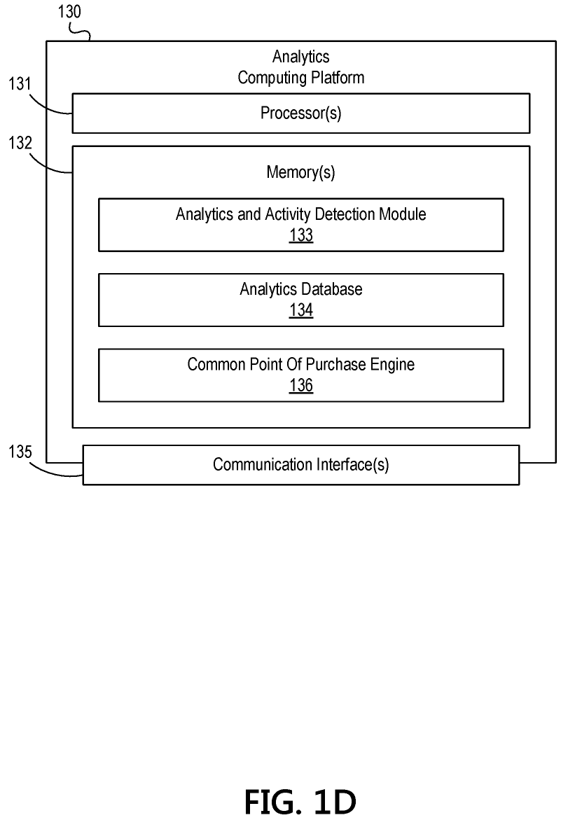

FIGS. 1A, 1B, 1C, and 1D depict an illustrative computing environment for detecting unauthorized usage in debit card transactions using a transaction management computing platform, an analytics computing platform, and a statistics computing platform in accordance with one or more example embodiments. Referring to FIG. 1A, computing environment 100 may include one or more computing devices and/or other computer systems. For example, computing environment 100 may include a transaction management computing platform 110, a statistics computing platform 120, an analytics computing platform 130, an automated teller machine (ATM) 140, and a user device 150. Each of transaction management computing platform 110, statistics computing platform 120, analytics computing platform 130, automated teller machine (ATM) 140, and user device 150 may be configured to communicate with each other, as well as with other computing devices and/or systems through network 160.

Transaction management computing platform 110 may be configured to maintain and manage information for transactions conducted at ATM 140. In some instances, transaction management computing platform 110 may receive data regarding each authorization request at ATM 140 and may subsequently generate a log for each transaction and authorization request at ATM 140 (e.g., including date, time, activities conducted during each transaction, and the like). Transaction management computing platform 110 may also be configured to perform other functions as discussed in greater detail below. In some instances, one or more actions or functions of transaction management computing platform 110 may be controlled or directed by analytics computing platform 130 to perform features for detection of unauthorized usage at ATM 140. In some instances, transaction management computing platform 110 may be implemented as a Hadoop server or a Hadoop distributed file system in order to maintain transaction data for thousands of customers at a financial institution.

Statistics computing platform may be configured to perform statistical analysis and generate baselines and metrics for transaction data at ATM 140. In some instances, statistics computing platform 120 may receive data regarding transactions at ATM 140 from transaction management computing platform 110 and may perform statistical analysis to create baselines and/or metrics indicative of normal or typical transactions occurring at ATM 140. For example, baselines and/or metrics may include average or standard threshold values for frequency of transactions in periods of time, periods of time between transactions, lengths of time for transactions, transaction amounts, and the like. In another example, baselines and/or metrics may include patterns such as similarities between order of activities occurring during each transaction at ATM 140, in which activities may include entering personal identification (PIN) numbers, balance inquiries, deposits, withdrawals, and the like at ATM 140. In some instances, the analytics computing platform 130 may utilize the baselines and/or metrics generated by statistics computing platform 120 to identify unusual activities occurring during transactions at ATM 140.

Analytics computing platform 130 may be configured to perform data analytics based on data provided by one or more devices and/or or computing platforms, control and/or direct actions of other devices and/or computing platforms, and/or perform other functions as discussed in greater detail below. In some instances, analytics computing platform 130 may perform and/or provide one or more unusual activity identification functions (e.g., for transactions occurring at ATM 140), data analysis functions, common point of purchase analysis functions, account flagging functions, and/or other related functions.

Automated teller machine (ATM) 140 may be configured to facilitate self-service transactions by users interacting with the ATM. ATM 140 may be associated with a financial institution and may be utilized by one or more customers of the financial institution to conduct various financial transactions. In some embodiments, ATM 140 may include a point of sale (POS) system which may be any location where a sale, purchase, or transaction may take place.

Example transactions that may be performed through the ATM 140 may include entering PIN numbers, inserting and/or swiping financial institution cards (e.g., debit cards), fund withdrawals, deposits, balance inquiries, updating customer preferences or account information, and the like. In some instances, transaction management computing platform 110, statistics computing platform 120, and/or analytics computing platform 130 may be configured to monitor a plurality of transactions occurring at ATM 140 in order to identify unusual activities and detect unauthorized usage of debit cards at ATM 140.

For example, one or more debit cards may be compromised, and an unauthorized user may use the one or more debit cards at ATM 140 to withdraw money from one or more financial accounts of customers of the financial institution. By monitoring transactions at the ATM 140, transaction management computing platform 110, statistics computing platform 120, and/or analytics computing platform 130 may facilitate in the detection of unauthorized usage of the one or more debit cards and preventing the unauthorized user from continuing to withdraw money from other compromised financial accounts of customers.

User device 150 may be any type of computing device configured to receive one or more notifications and/or a user interface, receive input via the user interface, and communicate via the user interface to one or more computing devices. For example, user device 150 may include a desktop computer, laptop computer, tablet computer, mobile device, smart phone, or the like. User device 150 may be associated with and/or operated by a user or customer with a financial account with the financial institution. In some embodiments, a user may receive a notification through user device 150 (e.g., from analytics computing platform 130 or from a server controlled by analytics computing platform 130), in which the notification indicates that the user's financial account has been compromised, resulting in unauthorized usage at ATM 140. In other embodiments, the notification transmitted to user device 150 may indicate that the user's financial account is at risk for being compromised or at risk for unauthorized usage. For example, the user may have conducted one or more transactions at a particular ATM 140 at which information for other financial accounts was compromised. Thus, the user may receive notification of possible unauthorized usage occurring as a precautionary measure on behalf of the financial institution.

Although only one ATM 140 and user device 150 are shown in FIG. 1A, it is understood that there may be any number of ATMs 140 and user devices 150 in computing environment 100. For example, there may be a plurality of ATMs 140, in which transaction management computing platform 110, statistics computing platform 120, and/or analytics computing platform 130 may be configured to perform various functions (e.g., monitoring transactions, identifying unusual activities, and the like) for each ATM in the plurality of ATMs 140. As illustrated in greater detail below, any and/or all of transaction management computing platform 110, statistics computing platform 120, analytics computing platform 130, ATM 140, and user device 150 may, in some instances, be special-purpose computing devices configured to perform specific functions. For instance, transaction management computing platform 110, statistics computing platform 120, analytics computing platform 130 may be and/or include server computers, desktop computers, laptop computers, tablet computers, smart phones, or the like that may include one or more processors, memories, communication interfaces, storage devices, and/or other components.

As stated above, computing environment 100 also may include one or more networks, which may interconnect one or more of transaction management computing platform 110, statistics computing platform 120, analytics computing platform 130, automated teller machine (ATM) 140, and user device 150. For example, computing environment 100 may include network 160. Network 160 may include one or more sub-networks (e.g., local area networks (LANs), wide area networks (WANs), wireless networks, or the like).

Referring to FIG. 1B, transaction management computing platform 110 may include one or more processors 111, memory 112, and communication interface 115. A data bus may interconnect processor(s) 111, memory 112, and communication interface 115. Communication interface 115 may be a network interface configured to support communication between transaction management computing platform 110 and one or more networks (e.g., network 160).

Memory 112 may include one or more program modules having instructions that when executed by processor(s) 111 cause transaction management computing platform 110 to perform one or more transaction management functions described herein and/or one or more databases that may store and/or otherwise maintain information which may be used by such program modules and/or processor(s) 111. In some instances, the one or more program modules and/or databases may be stored by and/or maintained in different memory units of transaction management computing platform 110 and/or by different computing devices that may form and/or otherwise make up transaction management computing platform 110.

For example, memory 112 may have, store, and/or include a transaction module 113, a transaction database and log 114, and a transaction processing engine 116. Transaction module 113 may have instructions that direct and/or cause transaction management computing platform 110 to manage transaction data received from ATM 140 through the communication interface 115 and generate transaction logs based on the transaction data. Transaction module 113 may store the transaction logs in transaction database and log 114, in which the transaction logs may include data regarding each transaction at ATM 140, including dates and times of each authorization request prior to transaction, times at which user was successfully authenticated to perform transactions, activities conducted during each transaction, account information (e.g., account numbers, debit card numbers, cardholder information, and the like), PIN number information for each account, and the like. In some instances, transaction database and log 114 may also store information used by transaction module 113 and/or transaction management computing platform 110 for managing transactions in computing environment 100 and/or in performing other functions.

Transaction processing engine 116 may have instructions that direct and/or cause transaction management computing platform 110 to obtain transaction data from ATM 140 in real-time, or near real-time, or periodically. In some instances, transaction processing engine 116 may collect and update transaction data every hour, every day, every week, or over any other interval of time. Transaction processing engine 116 may also facilitate optimization of the functions of transaction management computing platform 110 and may be configured to perform other functions for maintaining and managing transaction data.

Referring to FIG. 1C, statistics computing platform 120 may include one or more processors 121, memory 122, and communication interface 125. A data bus may interconnect processor(s) 121, memory 122, and communication interface 125. Communication interface 125 may be a network interface configured to support communication between statistics computing platform 120 and one or more networks (e.g., network 160). Memory 122 may include one or more program modules having instructions that when executed by processor(s) 121 cause statistics computing platform 120 to perform statistical analysis functions described herein and/or one or more databases that may store and/or otherwise maintain information which may be used by such program modules and/or processor(s) 121. In some instances, the one or more program modules and/or databases may be stored by and/or maintained in different memory units of statistics computing platform 120 and/or by different computing devices that may form and/or otherwise make up statistics computing platform 120.

For example, memory 122 may have, store, and/or include a statistics module 123, a statistics and metrics database 124, and a baseline and metrics engine 126. Statistics module 123 may have instructions that direct and/or cause statistics computing platform 120 to perform statistical analysis of transaction data received from transaction management computing platform 110 through the communication interface 125. For example, statistical analysis of transaction data may include identifying averages, means, medians, modes, ranges, variances, standard deviations, and the like for frequency of transactions in varying periods of time, periods of time between transactions, lengths of time for transactions, transaction amounts, and the like.

Statistics module 123 may store the statistical data obtained from statistical analysis in the statistics and metrics database 124, in which the statistical data may include averages, means, medians, modes, ranges, variances, standard deviations, and the like for frequency of transactions in varying periods of time, periods of time between transactions, lengths of time for transactions, transaction amounts, and the like. In some instances, statistics and metrics database 124 may also store information used by statistics module 123 and/or statistics computing platform 120 for performing statistical analysis and generating baselines in computing environment 100 and/or in performing other functions.

Baseline and metrics engine 126 may have instructions that direct and/or cause statistics computing platform 120 to generate baselines and/or metrics for measuring transactions at ATM 140. In some instances, baseline and metrics engine 126 may be configured to create baselines and/or metrics indicative of normal or typical transactions occurring at ATM 140 based on statistical analysis of the transaction data. For example, normal or typical transactions occurring at ATM 140 may include a plurality of customers of a financial institution conducting transactions at ATM 140, in which each customer may be authorized and have a verified financial account with the financial institution.

In order to identify behaviors or patterns indicative of normal or typical transactions occurring at ATM 140, baseline and metrics engine 126 may create baselines and/or metrics for transactions that typically occur at ATM 140 over various periods of time or at different times of the day and/or night. For example, baseline and metrics engine 126 may generate a baseline for the number of transactions that typically occur over a period of time (e.g., in 30 minutes, in an hour, in a day, in a week, or the like) based on transaction history at ATM 140. In some instances, this value may be referred to as a predetermined threshold level for the frequency of transactions that typically occur at ATM 140.

In another example, baseline and metrics engine 126 may generate a baseline for a period of time between typical transactions at ATM 140. For instance, normal or typical transactions conducted by authorized customers at ATM 140 may take a couple of minutes or any other period of time. Baseline and metrics engine 126 may determine a baseline period of time based on an average value of periods of time between typical transactions based on transaction history at ATM 140. In yet additional examples, baseline and metrics engine 126 may create baselines or threshold values for length of transaction times, transaction amounts, and the like.

In some instances, there may be a plurality of ATMs 140, and baseline and metrics engine 126 may generate baselines that are specific to each ATM 140. In particular, ATMs 140 may be located in different areas, which may result in a wide range of baselines and metrics for each ATM. For example, an ATM located on a street corner in a densely populated city may have a higher transaction volume (e.g., number of transactions in a period of time) than the transaction volume of an ATM located in a gas station in a rural area or suburb with lower population density. Thus, baseline and metrics engine 126 may be able to provide information that is specific to each ATM 140. In some instances, baseline and metrics engine 26 may collect and adjust or update baselines every hour, every day, every week, or over any other interval of time, and statistics computing platform 120 may be configured to transmit the updated baselines to analytics computing platform 130 in order to assess transaction data and identify unusual behaviors indicative of unauthorized usage.

Referring to FIG. 1D, analytics computing platform 130 may include one or more processors 131, memory 132, and communication interface 135. A data bus may interconnect processor(s) 131, memory 132, and communication interface 135. Communication interface 135 may be a network interface configured to support communication between analytics computing platform 130 and one or more networks (e.g., network 160). Memory 132 may include one or more program modules having instructions that when executed by processor(s) 111 cause analytics computing platform 130 to perform one or more unusual activity identification functions, data analysis functions, common point of purchase analysis functions, and/or account flagging functions described herein and/or one or more databases that may store and/or otherwise maintain information which may be used by such program modules and/or processor(s) 131. In some instances, the one or more program modules and/or databases may be stored by and/or maintained in different memory units of analytics computing platform 130 and/or by different computing devices that may form and/or otherwise make up analytics computing platform 130.

For example, memory 132 may have, store, and/or include an analytics and detection module 133, an analytics database 134, and a common point of purchase engine 136. Analytics and detection module 133 may have instructions that direct and/or cause analytics computing platform 130 to parse transaction data received from transaction management computing platform 110 through the communication interface 135 and compare the transaction data to baseline metrics obtained from the statistics computing platform 120. Based on comparing the parsed transaction data to the baselines, analytics and detection module 133 may identify unusual activity in a plurality of transactions occurring at ATM 140. In some instances, unusual activity may represent one or more activities during transactions that indicate unauthorized usage at ATM 140 by an individual or user who is not authorized to withdraw funds from a financial account. For example, an individual may walk up to an ATM 140 with several debit cards that do not belong to the individual, and the individual may use the debit cards to withdraw cash from the financial accounts of other customers. Analytics and activity detection module 133 may identify such unauthorized use cases by measuring transaction metrics with respect to the predetermined baselines from statistics computing platform 120.

For example, transaction metrics may include frequency values for number of transactions in predetermined periods of time, periods of time between transactions, lengths of time for transactions, transaction amounts, and the like. For example, transaction metrics may also include patterns such as similarities between order of activities occurring during each transaction at ATM 140, in which activities may include entering personal identification (PIN) numbers, balance inquiries, deposits, withdrawals, and the like at ATM 140. In some instances, analytics and activity detection module 133 may identify unusual activity by determining that a frequency value of the plurality of transactions that occurred over a predetermined period of time exceeds a predetermined threshold level. The predetermined threshold level may correspond to a baseline value for previous transactions occurring over the predetermined period of time based on transaction history at ATM 140. For example, if an ATM has up to 20 transactions occurring every hour during a weekday, then analytics and activity detection module 133 may identify unusual activity at the ATM if there are over 100 transactions occurring in an hour on another weekday.

In some instances, analytics and activity detection module 133 may identify unusual activity by identifying periods of time between each transaction in a plurality of transactions at ATM 140 and determining that at least one period of time is below a predetermined baseline period of time. For example, there may typically be a few minutes or another period of time between a first customer conducting a first transaction at an ATM and a second customer walking up to the ATM after the first customer and conducting a second transaction at the ATM. If the period of time is significantly shorter than the typical period of time between transactions, such as less than a few minutes (e.g., 20 seconds, 30 seconds, 1 minute, or the like), then the shorter period of time may indicate that an unauthorized user is performing transactions (e.g., rapid withdrawals) at the ATM with one or more debit cards that have been compromised. Thus, analytics and activity detection module 133 may identify this shorter period of time between transactions as an unusual activity indicative of unauthorized usage at ATM 140.

In some instances, analytics and activity detection module 133 may identify unusual activity by identifying a length of time for each transaction in the plurality of transactions at the ATM 140 and determining that the length of time for a subset of transactions is below a predetermined baseline length of time. For example, a typical transaction at an ATM may usually take a few minutes, including time for the user to enter or swipe his or her debit card, enter a PIN number, check an account balance, withdraw cash, print a receipt, and/or remove the debit card from the ATM. If transaction times for a subset of the transactions at the ATM are shorter than the baseline transaction time, then analytics and activity detection module 133 may identify these shorter transactions times as unusual activity indicative of unauthorized usage at ATM 140.

In some instances, analytics and activity detection module 133 may identify unusual activity by identifying a transaction amount for each transaction in a plurality of transactions at ATM 140 and determining one or more similarities between the transaction amounts for the plurality of transactions. For example, an authorized user or customer may typically withdraw smaller amounts of cash from his or her financial account at an ATM, such as $20, $50, or the like, whereas an unauthorized user performing rapid withdrawals at an ATM may attempt to quickly withdraw large amounts of cash (e.g., $200, $500, or several hundred or thousands of dollars) and/or similar amounts of cash from different accounts using several debit cards that have been compromised. If the transaction amounts are similar to each other or higher than a threshold transaction amount, then analytics and activity detection module 133 may identify the transactions amounts as an unusual activity indicative of unauthorized usage at ATM 140.

In additional instances, analytics and activity detection module 133 may identify unusual activity by detecting one or more activities occurring during each transaction in a plurality of transactions at the ATM 140 and identifying one or more similarities between the one or more activities occurring during each transaction in the plurality of transactions. For example, one or more activities at the ATM 140 may include entering PIN numbers, balance inquiries, deposits, withdrawals, printing receipts, and the like. If each of the transactions or several of the transactions at ATM 140 include multiple PIN entry failures, in which the user has entered the PIN number incorrectly more than once at ATM 140, then analytics and activity detection module 133 may identify this behavior as unusual activity indicative of unauthorized usage at ATM 140. In another example, if the majority of transactions at a particular ATM typically include activities such as balance inquiries and/or deposits, and several of the transactions at the particular ATM in the past hour have only included withdrawals without any other activities, then analytics and activity detection module 133 may identify this activity as an unusual activity indicative of unauthorized usage at the particular ATM.

Analytics and activity detection module 133 may store data regarding predetermined baselines, threshold values, periods of time, and the like in analytics database 134. In some instances, analytics database may also store information used by analytics and activity detection module 133 and/or analytics computing platform 130 for identifying unusual activities indicative of unauthorized usage in computing environment 100 and/or in performing other functions.

Common point of purchase engine 136 may have instructions that direct and/or cause analytics computing platform 130 to perform a common point or purchase analysis in response to an identification of at least one unusual activity in a plurality of transactions at ATM 140. Based on the common point of purchase analysis, common point of purchase engine 136 may generate a command directing analytics computing platform 130 to analyze each account corresponding to the plurality of transactions at ATM 140 to identify a common point of purchase for a subset of accounts. For example, the common point of purchase may include data regarding a time and location at which account information for at least one account in the subset of accounts was compromised. In order to analyze each account to identify the common point of purchase, common point of purchase engine 136 may generate a command directing analytics computing platform 130 to parse account information for each account corresponding to the plurality of transactions. Common point of purchase engine 136 may then generate a command directing analytics computing platform 130 to identify times and locations of previous transactions for each account corresponding to the plurality of transactions based on the parsing.

Subsequently, common point of purchase engine 136 may generate a command directing analytics computing platform 130 to identify the common point of purchase comprising a common location at which each account included a previous transaction. In response to identifying the common point of purchase, common point of purchase engine 136 may generate a command directing analytics computing platform 130 to flag the subset of accounts for which account information was compromised and transmit a notification to each user device 150 associated with users of the subset of flagged accounts. In some embodiments, analytics computing platform 130 may flag each account in the subset of accounts by adding an identifier or tag in the corresponding account information that marks each account as a high-risk account or as an account for which unauthorized usage has occurred.

Additionally, common point of purchase engine 136 may also generate a command directing analytics computing platform 130 to detect a second subset of accounts with transactions that occurred at the location at which account information for at least one account in the first subset of accounts was compromised. Common point of purchase engine 136 may then generate a command directing analytics computing platform 130 to flag the second subset of accounts and transmit a notification to each user device 150 associated with users of the second subset of flagged accounts. In additional embodiments, common point of purchase engine 136 may facilitate optimization of the functions of analytics computing platform 130 and may be configured to perform other functions for analyzing data, identify unusual activities indicative of unauthorized usage, perfuming common point of purchase analysis, and flagging accounts.

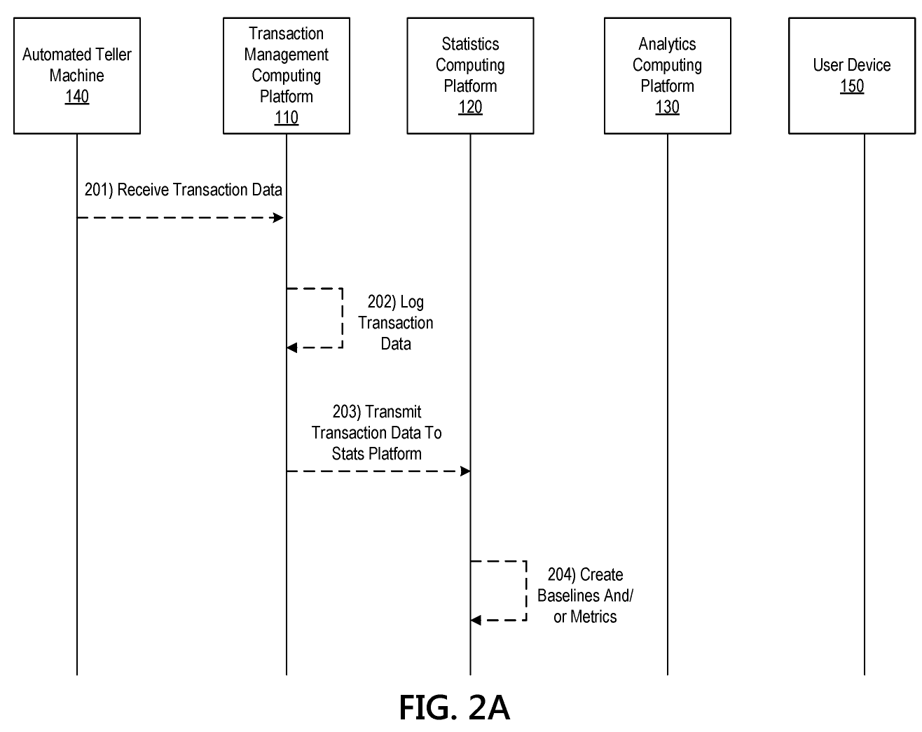

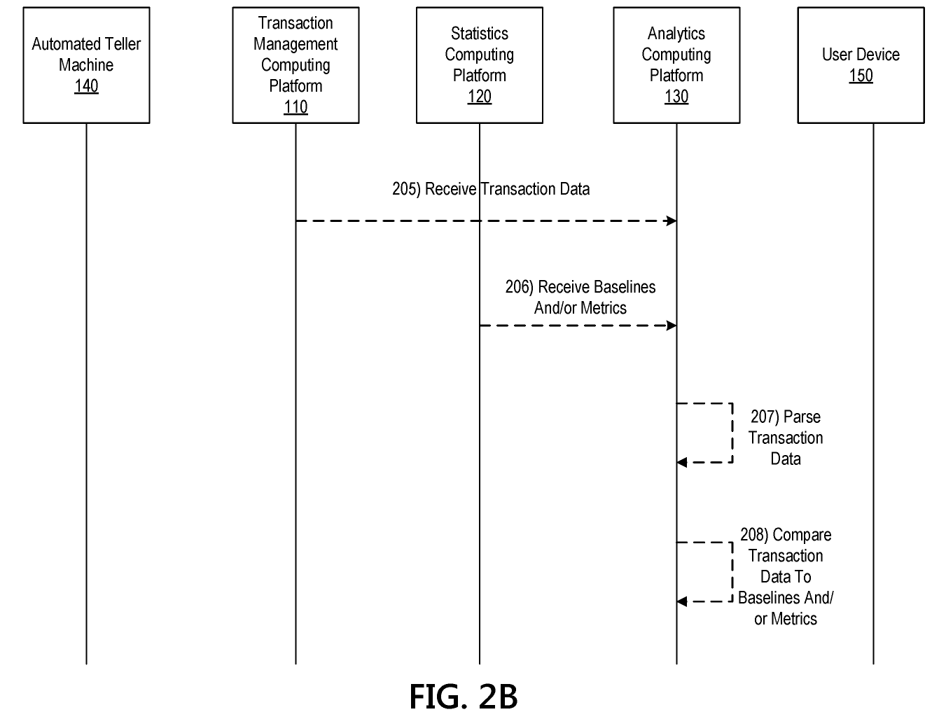

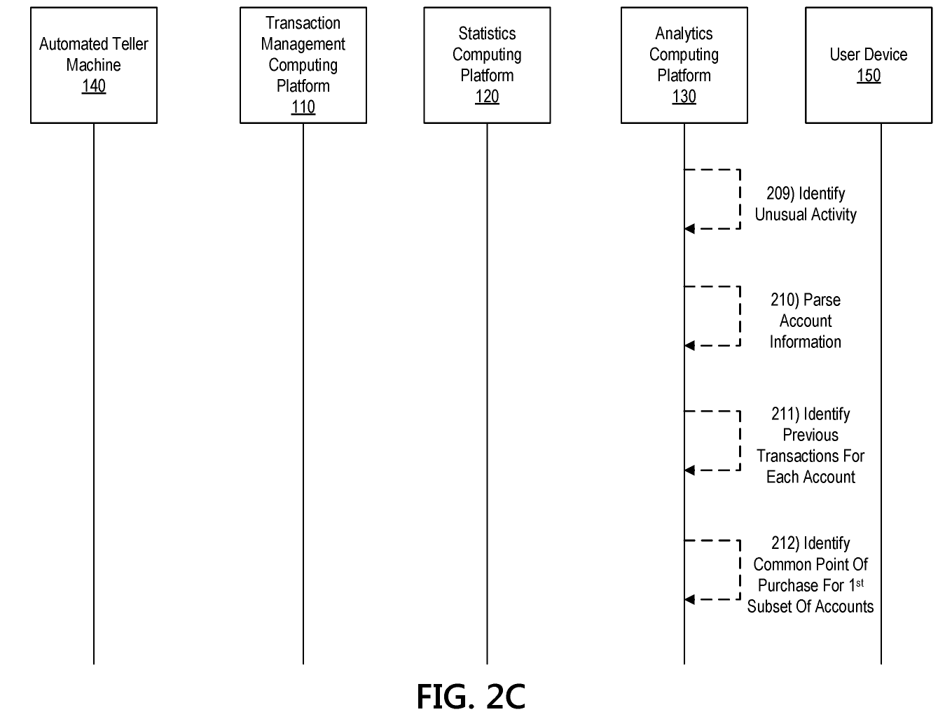

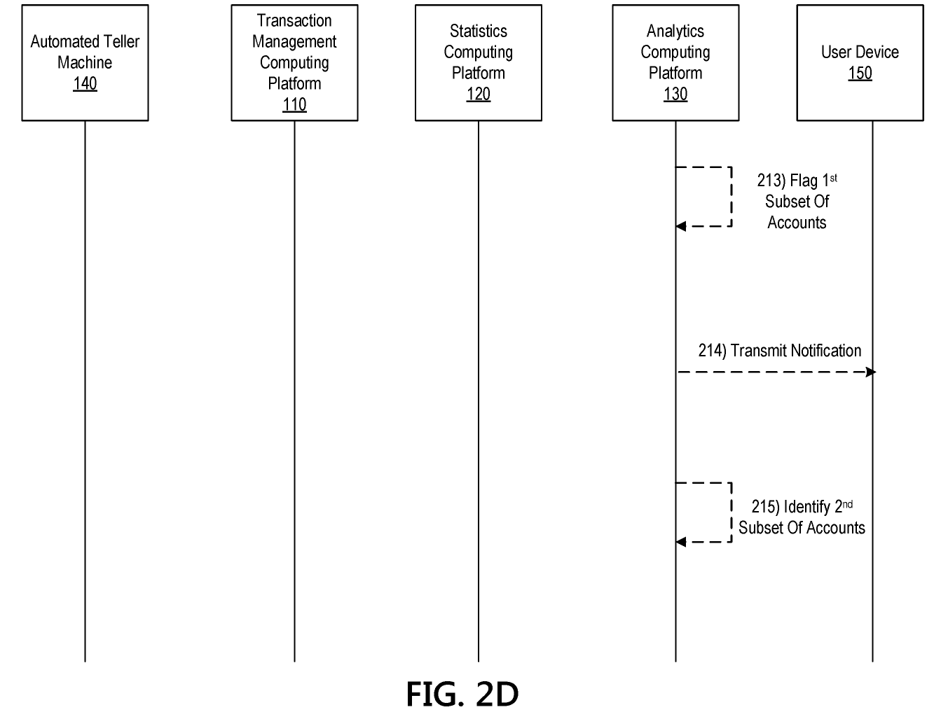

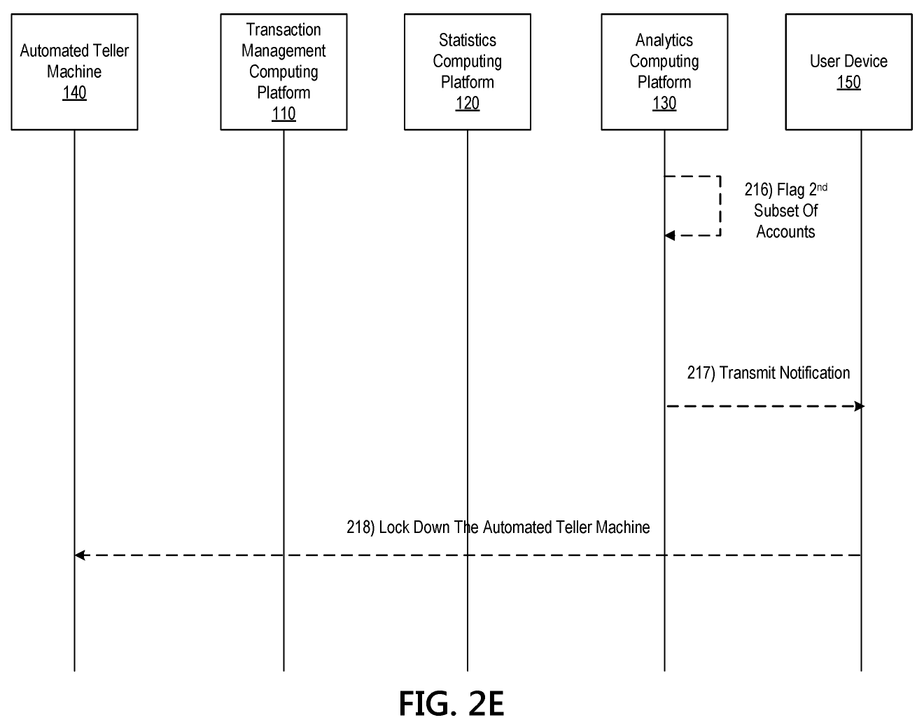

FIGS. 2A-2E depict an illustrative event sequence for detecting unauthorized usage in debit card transactions using a transaction management computing platform, an analytics computing platform, and a statistics computing platform in accordance with one or more example embodiments. Referring to FIG. 2A, at step 201, transaction management computing platform 110 may receive transaction data from ATM 140. For example, at step 201, transaction management computing platform 110 may receive data regarding each authorization request and transaction at ATM 140, including dates, times, activities conducted during each transaction, and the like.

In some instances, transaction management computing platform 110 may monitor a plurality of transaction at ATM 140 and receive transaction data by monitoring at least one of an authorization time, length of transaction time, one or more activities occurring during transaction, and a transaction amount for each transaction at ATM 140. In other instances, transaction management computing platform 110 may monitor a plurality of transaction at ATM 140 and receive transaction by monitoring video footage received from a camera installed at or near the ATM 140.

At step 202, transaction management computing platform 110 may log or store the transaction data. For example, at step 202, transaction management computing platform 110 may generate transaction logs for a plurality of transactions at ATM 140 and store the transaction logs in transaction database and log 114. In some instances, the transaction logs may include data regarding each transaction at ATM 140, including dates and times of each authorization request prior to transaction, times at which user was successfully authenticated to perform transactions, activities conducted during each transaction, account information (e.g., account numbers, debit card numbers, cardholder information, and the like), PIN number information for each account, and the like.

At step 203, transaction management computing platform 110 may transmit transaction data to statistics computing platform 120. For example, at step 203, transaction management computing platform 110 may transmit transaction data regarding authorization times, length of transaction time, one or more activities occurring during each transaction, and a transaction amount for each transaction at ATM 140 to statistics computing platform 120 in order for the statistics computing platform 120 to perform statistical analysis of the transaction data.

At step 204, statistics computing platform 120 may create baselines and/or metrics based on the transaction data received from transaction management computing platform 110. For example, at step 204, statistics computing platform 120 may perform statistical analysis of the transaction data by identifying averages, means, medians, modes, ranges, variances, standard deviations, and the like for frequency of transactions in varying periods of time, periods of time between transactions, lengths of time for transactions, transaction amounts, and the like. Based on the statistical analysis of the transaction data, statistics computing platform 120 may generate baselines and/or metrics indicative of normal or typical transactions occurring at ATM 140, in which the baselines and/or metrics may be used for assessing unusual activities during future transactions at ATM 140.

Referring to FIG. 2B, at step 205, analytics computing platform 130 may receive transaction data from transaction management computing platform 110. For example, at step 205, analytics computing platform 130 may receive data regarding a plurality of transactions that have occurred at ATM 140, in which the transaction data may include authorization times, length of transaction times, one or more activities occurring during each transaction, and a transaction amount for each transaction at ATM 140. At step 206, analytics computing platform 130 may receive one or more baselines and/or metrics from statistics computing platform 120.

For example, at step 206, analytics computing platform 130 may receive data regarding predetermined baselines, threshold values, periods of time, and the like, in which the one or more baselines and/or metrics are determining based on statistical analysis implemented by statistics computing platform 120. At step 207, analytics computing platform 130 may parse the transaction data received from transaction management computing platform 110. For example, at step 207, analytics computing platform 130 may parse the transaction data received from transaction management computing platform 110 in order to identify authorization times, length of transaction times, one or more activities occurring during each transaction, and a transaction amount for each transaction at ATM 140.

At step 208, analytics computing platform 130 may compare the transaction data to the one or more baselines and/or metrics. For example, at step 208, analytics computing platform 130 may compare the parsed transaction data to one or more baselines and/or metrics obtained from statistics computing platform 120. In some instances, analytics computing platform 130 may assess information regarding each transaction with respect to the baselines and/or metrics indicative of normal or typical transactions occurring at ATM 140. For example, normal or typical transactions occurring at ATM 140 may include a plurality of customers of a financial institution conducting transactions at ATM 140, in which each customer may be authorized and have a verified financial account with the financial institution.

Referring to FIG. 2C, at step 209, analytics computing platform 130 may identify at least one unusual activity in the plurality of transactions at ATM 140. For example, at step 209, analytics computing platform 130 may identify at least one unusual activity based on comparing the transaction data to the one or more baselines and/or metrics as discussed above. In some instances, unusual activity may represent one or more activities during transactions that indicate unauthorized usage at ATM 140 by an individual or user who is not authorized to withdraw funds from a financial account. Analytics computing platform 130 may identify such unauthorized use cases by measuring transaction metrics with respect to the predetermined baselines from statistics computing platform 120. For example, transaction metrics may include frequency values for number of transactions in predetermined periods of time, periods of time between transactions, lengths of time for transactions, transaction amounts, and the like. In another example, transaction metrics may also include patterns such as similarities between order of activities occurring during each transaction at ATM 140, in which activities may include entering personal identification (PIN) numbers, balance inquiries, deposits, withdrawals, and the like at ATM 140. In some instances, analytics computing platform 130 may identify at least one unusual activity in the plurality of transactions at ATM 140 in real-time (e.g., substantially contemporaneously with the occurrence of the at least one unusual activity).

At step 210, analytics computing platform 130 may parse account information for each account corresponding to the plurality of transactions. For example, at step 210, analytics computing platform 130 may parse account information each account corresponding to the plurality of transactions in response to identifying the at least one unusual activity in the plurality of transactions at ATM 140. In some instances, analytics computing platform 130 may parse account information to identify where and/or when account information was compromised, such as during a previous transaction at a particular ATM or point of sale location.

At step 211, analytics computing platform 130 may identify previous transactions for each account based on parsing account information. For example, at step 211, analytics computing platform 130 may identify times and locations of previous transactions for each account corresponding to the plurality of transactions. In some instances, each account may have a plurality of previous transactions at varying locations and times, and analytics computing platform 130 may assess each of these locations and times for further analysis.

At step 212, analytics computing platform 130 may identify a common point of purchase for a first subset of accounts. For example, at step 212, analytics computing platform 130 may identify the common point of purchase which includes a common location at which each account in the first subset of accounts included a previous transaction. For instance, analytics computing platform 130 may identify that multiple accounts made transactions at a particular ATM or that multiple accounts were utilized for purchase at a particular store in the mall. In this example, analytics computing platform 130 may identify the particular ATM or particular store in the mall to be the common location at which account information for at least one account in the subset of accounts was compromised.

Referring to FIG. 2D, at step 213, analytics computing platform 130 may flag the first subset of accounts. For example, at step 213, analytics computing platform 130 may flag the first subset of accounts in response to identifying the common point of purchase at which account information for at least one account in the subset of accounts was compromised. In some instances, analytics computing platform 130 may flag each account in the first subset of accounts by adding an identifier or tag in the corresponding account information that marks each account as a high-risk account or as an account for which unauthorized usage has occurred.

At step 214, analytics computing platform 130 may transmit a notification to user device 150. For example, at step 214, analytics computing platform 130 may transmit a notification to each user device 150 associated with users of the first subset of flagged accounts.

In some instances, the notification may indicate that the user's financial account has been compromised, resulting in unauthorized usage at ATM 140. For example, the notification may provide information to the user regarding the common point of purchase or location at which the user's account information may have been compromised.

At step 215, analytics computing platform 130 may identify a second subset of accounts. For example, at step 215, analytics computing platform 130 may detect a second subset of accounts with transactions that occurred at the location at which account information for at least one account in the first subset of accounts was compromised. In some instances, the second subset of accounts may include accounts of customers with account information that may also have been compromised. Thus, in order to prevent an unauthorized user from continuing to withdraw money from other compromised financial accounts of customers, analytics computing platform 130 may detect the second subset of accounts even before the detection of unauthorized usage of debit cards in these accounts.

Referring to FIG. 2E, at step 216, analytics computing platform 130 may flag the second subset of accounts. For example, at step 216, analytics computing platform 130 may flag the second subset of accounts in response to detecting that the second subset of accounts included transactions that occurred at the location at which account information for at least one account in the first subset of accounts was compromised. In some instances, analytics computing platform 130 may flag each account in the second subset of accounts by adding an identifier or tag in the corresponding account information that marks each account as a high-risk account or as an account for which unauthorized usage may have occurred or may possible occur.

In some instances, a flagged account may indicate that the customer might not be able to utilize his or her debit card for a temporary period of time due to the potential risk of account information being compromised. Once the potential risk has been mitigated, analytics computing platform 130 may remove the flag (e.g., remove the identifier or tag) from the customer's account so that the customer may be able to utilize his or her debit card for subsequent transactions at ATM 140.

At step 217, analytics computing platform 130 may transmit a notification to user device 150. For example, at step 217, analytics computing platform 130 may transmit a notification to each user device 150 associated with users of the second subset of flagged accounts. In some instances, the notification transmitted to user device 150 may indicate that the user's financial account is at risk for being compromised or at risk for unauthorized usage. For example, the notification may provide information to the user regarding the common point of purchase or location at which the user's account information may have been compromised.

At step 218, analytics computing platform 130 may generate a command directing ATM 140 to lock down. For example, at step 218, analytics computing platform 130 may generate and send, via one or more communication interfaces (e.g., communication interface 135), a command to ATM 140 directing, controlling, and/or otherwise causing ATM 140 to lock down to prevent users from utilizing the ATM 140 and having additional account information be compromised at the ATM 140. In some instances, the ATM 140 may be on lockdown until the potential risk of account information being compromised at ATM 140 has been mitigated. In some instances, analytics computing platform 130 may additionally or alternatively generate and send, via one or more communication interfaces (e.g., communication interface 135), one or more other commands to one or more other ATMs (e.g., different from ATM 140) directing, controlling, and/or otherwise causing the one or more other ATMs to lock down to prevent users from utilizing the one or more other ATMs. The one or more commands (which may, e.g., be generated and/or sent by analytics computing platform 130 to ATM 140 and/or the one or more other ATMs) may direct, control, and/or otherwise cause ATM 140 and/or the one or more other ATMs to lock down by directing, controlling, and/or otherwise causing ATM 140 and/or the one or more other ATMs to power off one or more displays and/or keypads, automatically close one or more physical barriers to external and/or user-facing portions of the ATMs (e.g., by rolling down and/or releasing one or more covers, gates, doors, and/or other physical barriers), disabling one or more external and/or internal components of the ATMs, locking and/or disabling one or more electronic locks and/or entry mechanisms (e.g., to a vestibule containing one or more

ATMs), and/or the like.

In additional embodiments, analytics computing platform 130 may generate a command to direct the ATM 140 to activate a light installed at the ATM 140 to turn on in order to indicate that unauthorized usage is currently occurring (e.g., or has previously occurred). By activating the light to turn on, analytics computing platform 130 may thwart unauthorized users from continuing to utilize compromised account information to obtain money from financial accounts.

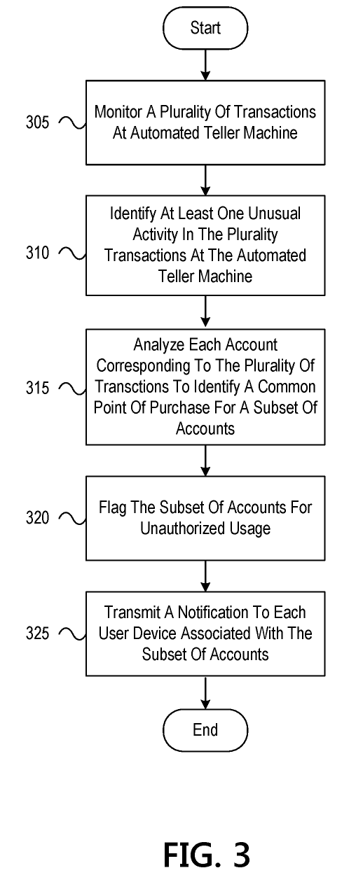

FIG. 3 depicts an illustrative method for detecting unauthorized usage in debit card transactions using a transaction management computing platform, an analytics computing platform, and a statistics computing platform in accordance with one or more example embodiments. Referring to FIG. 3, at step 305, a computing platform having at least one processor, a memory, and a communication interface may monitor a plurality of transactions at an automated teller machine (ATM). At step 310, the computing platform may identify at least one unusual activity in the plurality of transactions at the ATM.

In some instances, the computing platform may identify at least one unusual activity by at least one of identifying the frequency of transactions in a predetermined period of time, detecting a respective period of transaction time between each transaction in the plurality of transactions, detecting a length of time for each transaction in the plurality of transactions, identifying similarities between transaction amounts for the plurality of transactions, identifying transaction amounts above predetermined threshold values for the plurality of transactions, identifying similarities between one or more activities occurring during each transaction in the plurality of transactions, and the like.

At step 315, in response to identifying the at least one unusual activity in the plurality of transactions at the ATM, the computing platform may analyze each account corresponding to the plurality of transactions to identify a common point of purchase for a subset of accounts. In some instances, the common point of purchase may include a data regarding a time and location at which account information for at least one account in the subset of accounts was compromised. At step 320, in response to identifying the common point of purchase, the computing platform may flag the subset of accounts for unauthorized usage. At step 325, the computing platform may transmit a notification to each user device associated with the subset of accounts to indicate that unauthorized usage has occurred.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
monitor a plurality of transactions at an automated teller machine;
identify, by the at least one processor, at least one unusual activity in the plurality transactions at the automated teller machine;
in response to identifying the at least one unusual activity in the plurality of transactions at the automated teller machine, analyze, by the at least one processor, each account corresponding to the plurality of transactions to identify a common point of purchase for a subset of accounts; and
in response to identifying the common point of purchase, flag the subset of accounts.

2. The computing platform of claim 1, wherein the memory stores additional computer-readable instructions that, when executed by the at least one processor, cause the computing platform to:
transmit, via the communication interface, a notification to each user device associated with users of the subset of accounts.

3. The computing platform of claim 1, wherein identifying at least one unusual activity in the plurality of transactions comprises:
identify, by the at least one processor, a frequency value of the plurality of transactions that occurred over a predetermined period of time at the automated teller machine; and
determine that the frequency value of the plurality of transactions that occurred over the predetermined period of time exceeds a predetermined threshold level.

4. The computing platform of claim 3, wherein the predetermined threshold level corresponds to a baseline value for previous transactions occurring over the predetermined period of time based on transaction history at the automated teller machine.

5. The computing platform of claim 4, wherein the memory stores additional computer-readable instructions that, when executed by the at least one processor, cause the computing platform to:
determine the predetermined threshold level by calculating an average number of transactions that occur at the automated teller machine over previous predetermined periods of time; and
adjust the predetermined threshold level according to the average number of transactions.

6. The computing platform of claim 1, wherein identifying at least one unusual activity in the plurality of transactions comprises:
identifying, by the at least one processor, a respective period of time between each transaction in the plurality of transactions at the automated teller machine, resulting in a plurality of periods of time; and
determining that at least one period of time is below a predetermined baseline period of time.

7. The computing platform of claim 1, wherein identifying at least one unusual activity in the plurality of transactions comprises:
identifying, by the at least one processor, a length of time for each transaction in the plurality of transactions at the automated teller machine; and
determining that the length of time for a subset of transactions is below a predetermined baseline length of time.

8. The computing platform of claim 1, wherein identifying at least one unusual activity in the plurality of transactions comprises:
identifying, by the at least one processor, an amount for each transaction in the plurality of transactions at the automated teller machine; and
determining one or more similarities between transaction amounts for the plurality of transactions at the automated teller machine.

9. The computing platform of claim 1, wherein identifying at least one unusual activity in the plurality of transactions comprises:
identifying, by the at least one processor, an amount for each transaction in the plurality of transactions at the automated teller machine; and
determining that a subset of transaction amounts comprise amounts above a predetermined threshold value.

10. The computing platform of claim 1, wherein identifying at least one unusual activity in the plurality of transactions comprises:
detecting, by the at least one processor, one or more activities occurring during each transaction of the plurality of transactions at the automated teller machine; and
identifying, by the at least one processor, one or more similarities between the one or more activities of each transaction of the plurality of transactions at the automated teller machine.

11. The computing platform of claim 10, wherein the one or more activities comprise at least one of inserting debit cards into the automated teller machine, entering personal identification (PIN) numbers, balance inquiries, deposits, and withdrawals at the automated teller machine.

12. The computing platform of claim 1, wherein monitoring the plurality of transactions at the automated teller machine comprises monitoring at least one of an authorization time, length of transaction time, one or more activities occurring during transaction, and a transaction amount for each transaction at the automated teller machine.

13. The computing platform of claim 1, wherein monitoring the plurality of transactions at the automated teller machine comprises monitoring video footage received from a camera installed at the automated teller machine.

14. The computing platform of claim 1, wherein the plurality of transactions comprises withdrawals conducted by one or more users at the automated teller machine.

15. The computing platform of claim 1, wherein analyzing each account corresponding to the plurality of transactions to identify a common point of purchase for a subset of accounts comprises:
parsing, by the at least one processor, account information for each account corresponding to the plurality of transactions;
identifying, by the at least one processor, times and locations of previous transactions for each account corresponding to the plurality of transactions; and
identifying, by the at least one processor, the common point of purchase comprising a common location at which each account included a previous transaction.

16. The computing platform of claim 1, wherein the common point of purchase comprises data regarding a time and location at which account information for at least one account in the subset of accounts was compromised.

17. The computing platform of claim 16, wherein the memory stores additional computer-readable instructions that, when executed by the at least one processor, cause the computing platform to:
in response to identifying the common point of purchase, detect a second subset of accounts with transactions that occurred at the location at which account information for at least one account in the subset of accounts was compromised; and
flag the second subset of accounts.

18. The computing platform of claim 17, wherein the memory stores additional computer-readable instructions that, when executed by the at least one processor, cause the computing platform to:
transmit, via the communication interface, a notification to each user device associated with users of the second subset of flagged accounts.

19. A method comprising;
at a computing platform comprising at least one processor, memory, and a communication interface:
monitoring, by the at least one processor, a plurality of transactions at an automated teller machine;
identifying, by the at least one processor, at least one unusual activity in the plurality of transactions at the automated teller machine;
in response to identifying the at least one unusual activity in the plurality of transactions at the automated teller machine, analyzing, by the at least one processor, each account corresponding to the plurality of transactions to identify a common point of purchase for a subset of accounts;
in response to identifying the common point of purchase, flagging the subset of accounts; and
transmitting, via the communication interface, a notification to each user device associated with the subset of flagged accounts.

20. One or more non-transitory computer-readable media storing instructions that, when executed by a computing platform comprising at least one processor, memory, and a communication interface, cause the computing platform to:
monitor, by the at least one processor, a plurality of transactions at an automated teller machine;
identify, by the at least one processor, at least one unusual activity in the plurality transactions at the automated teller machine;
in response to identifying the at least one unusual activity in the plurality of transactions at the automated teller machine, analyze, by the at least one processor, each account corresponding to the plurality of transactions to identify a common point of purchase for a subset of accounts;
in response to identifying the common point of purchase, flag the subset of accounts; and
transmit, via the communication interface, a notification to each user device associated with the subset of flagged accounts.
